(19) United States
(12) Patent Application Publication
(10) Pub. No.: US 2007/0219289 A1
(43) Pub. Date: Sep. 20, 2007

(54) Friction Material

(75) Inventors: Mark Phipps, Cookeville, TN (US); Gregory Vyletel, Ann Arbor, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL WORLD WIDE, INC., Southfield, MI (US)

(21) Appl. No.: 11/685,983

(22) Filed: Mar. 14, 2007

Related U.S. Application Data
(60) Provisional application No. 60/782,353, filed on Mar. 15, 2006.

(51) Int. Cl. C08J 5/14

(52) U.S. Cl. 523/152; 523/155

(57) ABSTRACT

A friction material includes a binder, a reinforcement fiber, and a friction modifier which in turn includes flat layered titanate particles and baryte particles, wherein the baryte particles constitute less than 25% by volume of the friction material. The flat layered titanate particle may include alkali metal titanate particles, and more specifically potassium lithium titanate particles. Other flat layered titanates, including alkali metal alkaline earth metal titanates may also be used. The titanate particles may be used in an amount of 3-25% by volume of the friction material, and more specifically 5-15% by volume thereof. They may also have particle sizes ranging from 0.1-500 μm, and more specifically 1-30 μm, and even more specifically 15-30 μm. The friction material may include a binder or binders in an amount of about 8-31% by volume of the friction material. The friction material may also include reinforcement fibers in an amount of about 2-13% by volume of the friction material. These friction material may be used for any friction component including use in industrial machinery and vehicles, but are particularly useful as friction materials for use in various brake and clutch components.

### CROSS-REFERENCE TO RELATED APPLICATIONS

This patent application claims priority to U.S. provisional patent application Ser. No. 60/782,353 filed on Mar. 15, 2006 which is hereby incorporated herein by reference in its entirety.

### BACKGROUND OF THE INVENTION

1. Field of the Invention

The present invention relates to friction material. More particularly it relates to a non-asbestos organic friction material which may be used in brake pads, brake linings, clutch facings, and other friction components used in industrial machinery, vehicles and a wide variety of other friction control applications.

2. Related Art

Braking linings, clutch facings and other friction members typically include a friction material that is reinforced with one or more types of fiber to improve their strength, friction characteristics or other properties. Common fibers include both inorganic and organic fibers, or combinations of them. Inorganic fibers include fibers of various glass, ceramic, metal, cermet, mineral and other inorganic materials. Common inorganic fibers include various silicate glasses, steel, asbestos and potassium titanate fibers. Common organic fibers include various polymeric materials. Common organic fibers include aramid, ultra high density polyethylene, polybenzoxazole, polyacrilonitrile (PAN), cellulose and other carbon-containing or silicon-containing polymeric fibers.

Potassium hexatitanate (K₂Ti₆O₁₃), frequently referred to as potassium titanate, fiber is well known in the industry as an abrasive inorganic fiber that improves the strength and other properties of various friction materials, such as improving the wear resistance and longevity of friction linings. Potassium titanate fibers, particularly in a whisker form, are also known to provide good heat resistance and improve the friction coefficient of the friction materials to which they are added.

However, various drawbacks associated with the use of potassium titanate fiber have been reported, such as transfer of the fibers from the friction material to mating friction members and resultant decreases in noise and wear performance, such that there is a desire for improved longevity and improved friction material properties over that which potassium titanate fibers can provide. While there have been various attempts to replace potassium titanate fibers with other materials, typically the heat resistance, wear resistance, coefficient of friction, or longevity of the friction material is detrimentally affected by the replacement.

Other titanate materials having non-fibrous morphologies have been reported for use in friction materials as friction modifier constituents, including potassium lithium titanate and potassium magnesium titanate materials. These materials are reported to improve certain friction properties when used in certain friction materials, including wear resistance. However, to Applicants knowledge these reports have not included information about how the characteristic performance of these materials, including the improvements noted, may be affected, and particularly further improved in conjunction with their use with other common friction modifier constituents, such as baryte.

### SUMMARY OF THE INVENTION

In one aspect, the present invention relates to a friction material, and more particularly a friction material which includes a binder, a reinforcement fiber, and a friction modifier which in turn includes flat layered titanate particles and baryte particles, wherein the baryte particles constitute less than 25% by volume of the friction material. Controlling the amount of the baryte particles to this level improves the wear resistance of these friction materials over that of friction materials which include flat layered titanate particles and baryte particles above this range. The wear resistance or pad life improvement of friction materials which utilize flat layered titanates decreases with increasing amounts of baryte particles.

In another aspect, the flat layered titanate particle may include alkali metal titanate particles, and more specifically potassium lithium titanate particles. Other flat layered titanates, including alkali metal alkaline earth metal titanates may also be used.

In another aspect, the titanate particles may be used in an amount of 3-25% by volume of the friction material, and more specifically 5-15% by volume thereof. They may also have particle sizes ranging from 0.1-500 μm, and more specifically 1-30 μm, and even more specifically 15-30 μm.

In another aspect, the friction material may include a binder or binders in an amount of about 10-21% by volume of the friction material.

In another aspect, the friction material may also include reinforcement fibers in an amount of about 2-13% by volume of the friction material.

In another aspect, these friction materials may be used for any friction component including use in industrial machinery and vehicles, but are particularly useful as friction materials for use in various brake and clutch components.

### BRIEF DESCRIPTION OF THE DRAWINGS

These and other features and advantages of the present invention will become more readily appreciated when considered in connection with the following detailed description and appended drawings, wherein:

FIG. 1 is a schematic representation of a friction material used in a friction member and an associated backing member.

Further scope of applicability of the present invention will become apparent from the following detailed description and claims. However, it should be understood that the detailed description and specific examples, while indicating preferred embodiments of the invention, are given by way of illustration only, since various changes and modifications within the spirit and scope of the invention will become apparent to those skilled in the art.

### DETAILED DESCRIPTION OF THE PREFERRED EMBODIMENT

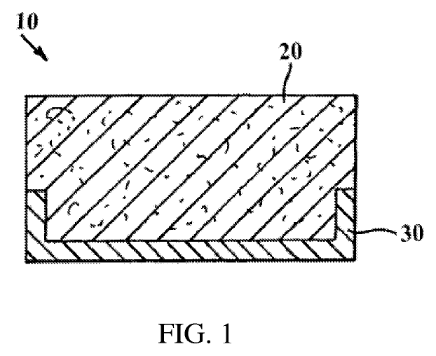

The present invention includes a friction material suitable for use in a wide variety of friction control applications. Referring to FIG. 1, the friction material 10 is particularly suited for use to form a molded friction member 20, including various configurations of friction pads, linings, facings or the like, that may be attached to a backing member 30, including various components of brakes, clutches or other friction control components, assemblies or systems, such as, for example, various forms of disc brake pads, drum brake shoes, drum brake liners, brake bands, clutch facings, clutch plates and other friction control components. The present invention is particularly suitable for use in various non-asbestos organic friction materials, but use in semi-metallic friction materials may also be possible and is not precluded.

The friction material of the present invention includes a binder, a reinforcement fiber and a friction modifier, where the friction modifier includes both flat layered titanate particles and baryte particles, such that the baryte particles are present in an amount which is generally less than about 25% by volume of the friction material. The friction materials of the invention may be generally described as mixtures of the constituents described above, specifically substantially homogeneous mixtures of these constituents, but should also be understood to include non-homogeneous mixtures and other combinations of these constituents. Applicants have discovered that these friction materials 10 have improved wear characteristics, including increased brake pad life, when used as molded friction members 20 attached to backing members 30 of the types described above. These friction materials 10 are particularly improved over other friction materials which include whisker-like titanates, such as potassium titanates. They are also improved over those friction materials which have incorporated flat layered titanates, such as lithium potassium titanate, but with amounts of barytes of 25% by volume or more. Applicants have discovered that by controlling the amount of baryte particles to an amount which is less than about 25% by volume of the friction material 10 improves the wear characteristics as compared to materials which include baryte in an amount of 25% by volume or more of the friction material.

As noted above, the friction modifier constituent of the friction material will include both flat layered titanate particles and baryte particles, such that the baryte particles are present in an amount which is generally less than about 25% by volume of the friction material. As used herein, the term flat layered titanates is intended to encompass a number of alkaline and alkaline earth metal titanate materials with a generally flat, planar, platy, scaly or flake-like particle morphology. These plates are generally irregularly shaped and frequently have a broad distribution of particle sizes about the average or median particle size. It is believed that these particles may have an average diameter (d₅₀) in a broad range of about 0.1-500 μm, with a more preferred range being about 1-100 μm, and an even more preferred range being about 1-30 μm. These ranges will vary depending on the particular flat layered titanate or combination of titanates selected. When using potassium lithium titanate as the flat layered titanate, the preferred operating range of average diameter (d₅₀) used by Applicants is about 15-30 μm.

As noted, the flat layered titanates of the invention are irregular in shape having a length which is generally greater than the width, such that they are frequently described as having a major and minor particle diameters which may be compared as an aspect ratio. Depending on the flat layered titanate utilized, it is believed that this aspect ratio should generally be about 10 or less, and in many it is more specifically about 5 or less. The thickness of the flat layered titanates of the invention is also much smaller than the length. This is in contrast to columnar or whisker shaped titanates which are currently used in various friction materials and which generally have a larger aspect ratio. The flat layered titanates of the invention may also be used in combination with other titanates, such as columnar, whisker or fiber shaped titanates, including various potassium titanates having this particle morphology.

A preferred flat layered titanate is potassium lithium titanate, such as that sold by Otsuka Chemical Co., Ltd. under the name TERRACESS L which has the formula K_{0.5-0.7}Li_{0.27}Ti_{1.73}O_{3.85-3.95} and an average particle size of 15-30 μm. Potassium lithium titanates having slightly different stoichiometric ratios may also be possible. A titanate of this type and method for its manufacture is described, for example, in U.S. Pat. No. 7,078,009 B2 which is hereby incorporated herein by reference.

It is believed that other flat layered alkaline metal titanates may also be suitable for use, including sodium titanate, potassium tetratitanate (K₂O.4TiO₂), potassium hexatitanate (K₂O.6TiO₂) and potassium octatitanate (K₂O.8TiO₂). These alkaline metal titanates may also have slightly different stoichiometric ratios. These titanates and methods for their manufacture are described, for example, in U.S. Pat. No. 6,677,041 B1 which is hereby incorporated herein by reference.

Further, it is also believed that flat layered alkaline metal alkaline earth metal titanates are suitable for use as a flat layered titanate of the invention, including potassium magnesium titanate. These titanates and methods for their manufacture are described, for example, in US Published Patent Application 2003/0147804 A1 which is hereby incorporated herein by reference.

Still further, it is also believed that other flat layered titanates, including those titanates having the general formula:

AₓM_{y}Ti_{2-y}O₄

wherein A represents an alkaline metal other than lithium; M represents one or more elements selected from the group consisting of lithium, magnesium, zinc, nickel, copper, iron, aluminum, gallium and manganese; x is a number from 0.5-1.0; and y is a number from 0.25-1.0; and flat layered titanic acids represented by general formula:

Hₓ(M′_{y})_{z}Ti_{2-y}O₄.H₂O

wherein M′ represents one or more elements selected from the group consisting of lithium, magnesium, zinc, nickel, copper, iron, aluminum, gallium and manganese; x is a number from 0.5-1.0; y is a number from 0.25-1.0; z is 0 or 1; and n is a number of 0≦n≦2; may also be suitable for use as a flat layered titanates in accordance with this invention. These titanates and methods for their manufacture are described, for example, in U.S. Pat. No. 6,432,187 B1 which is hereby incorporated herein by reference.

The flat layered titanate is generally 3-25% by volume of the friction material. It has been found that use of potassium lithium titanate in the amount of approximately 5-20% by volume improves the longevity of the friction material, with a range of 5-15% being even more preferred. However, as one skilled in the art would recognize, any change in the amount of the flat layered titanate, even within the given range, would require a change in the amount of the other components included in the friction material and may affect the characteristics of the friction material. Therefore, for each material forming the friction material, the ranges given are the ranges which have been found to create a suitable friction material with the desired characteristics, including in particular, the longevity of the friction material. While the broad range provides the acceptable range for each material, a narrower range has been provided for each material to further define a range which has even more desirable characteristics as a friction material, including increased longevity, such as measured, for example, as increased pad life of a brake pad formed from the friction material of the invention. If both flat layered titanate as well as columnar or fibrous potassium titanate are used, the combined total percentage of titanates by volume of the friction material generally falls within the 3-25% range described above for the flat layered titanate. The flat layered titanates may be treated with a surface agent such as a silane-coupling agent, but such surface treatment is not required.

Baryte is a commonly used and desirable friction modifier that finds widespread use in many friction materials. In addition to the flat layered titanates described above, the friction material of the invention also includes baryte particles in an amount which comprises less than about 25% by volume of the friction material. More specifically, the amount of baryte particles is less than about 17% by volume of the friction material, and most specifically about 7-17% by volume of the friction material. Baryte is a naturally occurring mineral form of barium sulfate (BaSO₄) and baryte as used herein includes all naturally occurring, chemically or physically modified or synthesized forms of barium sulfate (BaSO₄). When describing the amount of baryte particles herein as being less than a maximum value, it will be understood that this does not include zero, as friction material 10 must include some amount of baryte particles. The baryte particles may also include certain inherent trace impurities associated with the raw material from which the baryte is extracted. Baryte particles comprising about 96% or more by volume of baryte, with the balance being trace impurities, having an average particle size of about 8 μm and a generally spherical particle morphology are known to produce the friction control performance improvements described herein; however, any baryte particles suitable to produce an improvement in the wear performance of the friction material described herein are included within the scope of this invention, including those of having different purities, average particle diameters and particle morphologies.

In addition to the flat layered titanate particles and baryte particles, the friction modifier of the invention may also include various other broad categories of friction modifying constituents, including: lubricants; abrasives; various fillers, including inorganic and organic fillers; rust preventatives; wetting agents and other constituents that affect the friction control properties of the friction material. In a non-asbestos organic friction material, abrasives generally may include metal oxides such as alumina, silica, magnesia, zirconia, chromium oxide, quartz, zircon flour (zircon silicate), zirconium oxide, titanium oxide, iron oxide and other known abrasives, either separately or in any combination. Lubricants generally may include carbon black, graphite, various metal sulfides and other known lubricants, either separately or in any combination. Suitable fillers may include organic and inorganic fillers in any combination. Inorganic fillers may include non-ferrous metals such as aluminum, copper, zinc and tin, hydrated and non-hydrated lime, clay, mica, talc, diatomite, antigorite, sepiolite, montmorillonite, various zeolites, various silicates including quartz and calcium carbonate and other known inorganic friction modifying constituents, either separately or in any combination. Inorganic fillers may also include fibrous potassium titanates, although titanates may also be categorized as a fiber in certain friction materials. The organic fillers may include vulcanized or unvulcanized natural and synthetic rubber; cashew resin; resin dust, rubber dust and other known organic friction modifying constituents, either separately or in any combination. While the friction modifier constituents have been grouped into various sub-categories including lubricants; abrasives and various fillers, including inorganic and organic fillers for convenience based on their typical function in a friction material, it will be recognized that these constituents may be characterized and grouped otherwise (i.e., lubricants as fillers) without departing from the practice of the invention as described herein. The total amount of friction modifiers is generally about 69-88% by volume of the friction material, and more specifically about 75-83% by volume thereof. In view of the composition ranges described above for the flat layered titanates and the baryte, the total amount of other friction modifiers generally ranges from about 38-85% by volume of the friction material, and more specifically about 51-63% by volume thereof.

The reinforcement fibers generally include any known reinforcement fibers currently in use in the industry such as resin fibers such as various aramids, acrylics and polyamides; pure metal and metal alloy fibers such as those of iron, steel and copper; carbon fibers; glass fibers; ceramic fibers; mineral fibers such as rock wool; cellulose fibers, fibrous titanates, such as potassium titanate, and the like, either individually or in any combination. The reinforcement fibers generally make up about 2-13% by volume of the friction material, and more specifically about 3-7% by volume of the friction material.

The binder may generally include any known binder currently in use in the industry such as various organic binders and inorganic binders. Examples of organic binders include thermosetting resins such as phenol, formaldehyde, melamine, epoxy, acrylic, aromatic polyester and urea resins; elastomers such as natural rubber, nitrile, butadiene, styrene-butadiene, chloroprene, polyisoprene, acrylic, high styrene rubbers and styrene-propylene-diene copolymer; thermoplastic resins such as polyamide, polyphenylene sulfide, polyether, polyimide, polyether ether ketone and thermoplastic crystalline polyester resins. Examples of inorganic binders include alumina sol, silica sol, silicone resins and the like. Of these binders, the thermosetting resins are particularly preferred for a wide variety of friction material applications. The binder generally makes up about 8-31% by volume of the friction material, and more specifically about 10-21% by volume of the friction material, and even more specifically about 14-18% by volume of the friction material.

It is well understood by one skilled in the art that the relative amounts of the reinforcement fiber, binder and friction modifier that make up friction material 10 may be varied to provide different material characteristics that may be demanded in different friction control applications. For example, the coefficient of friction, mechanical characteristics, wear resistance characteristics, vibration damping characteristics, audible noise characteristics, and any combination of these characteristics, may be adjusted singularly or in combination by adjusting the relative amounts of the reinforcement fiber, binder and friction modifier constituents of the friction material.

Any suitable method may be utilized to produce the friction material by mixing a reinforcement fiber, binder and friction modifier, wherein the friction modifier includes flat layered titanate particles and baryte particles, such that the baryte particles comprise less than about 25% by volume of the friction material, into a substantially homogeneous mixture, such as a pre-polymer mixture, and then converting the mixture to a hard dense finished friction material, such as by completing the polymerization reaction. An exemplary description of a method of making the friction material using a pre-polymer binder, such as a thermoset resin, is given below.

The friction material constituents may be mixed into a pre-polymer mixture using any suitable mixing process, depending largely on the specific friction material and the specific constituents. The initial constituents may be pre-mixed in any desired combination. They may be added together in any combination prior to the start of mixing and then mixed, or may be added to a mixer sequentially in any combination, depending on the requirements of the specific friction composition and the constituents being used. Mixing may be performed using any suitable mixing device, depending on the constituents and requirements associated with the process reactions, homogeneity requirements and other factors.

Once the friction material constituents have been mixed, the pre-polymer mixture is formed using any suitable process for forming, and polymerized using any suitable process for polymerizing the friction material constituents to produce a friction member 20 having the requisite friction material characteristics, such as those described herein. Forming and polymerizing may be performed separately in any sequence, or alternately may be performed simultaneously as a forming/polymerizing step.

One exemplary method for forming the pre-polymer mixture employs extrusion, calendar rolling or a combination thereof. The pre-polymer mixture using a liquid resin is placed under pressure in an extrusion nozzle with an appropriate shape, or alternately, by passing the material between two opposing rotating calendar rolls, and forced under pressure to conform to the shape of the nozzle or the calendar rolls as the pressure extrudes or calendars, respectively, the material through the particular device. Polymerizing may be accomplished by applying heat during the extrusion/calendaring or separately afterward, or both.

Another exemplary method for forming the friction material and polymerizing the pre-polymer mixture employs cold forming. In these method, the pre-polymer mixture uses a solid resin binder. The pre-polymer mixture is stamped or otherwise pressed under high pressure to a specific shape and then cured with low or no pressure at temperatures sufficient, to complete the chemical polymerization reaction and cure the resin. Typically, the temperature used for curing may exceed those needed to ensure polymerization of pre-polymer mixture.

Yet another example of the steps of forming and polymerizing the pre-polymer friction material mixture employs hot forming. In this step, the pre-polymer friction material mixture may use either a solid resin binder or a liquid resin binder, or a combination of both. The pre-polymer friction material mixture is placed in a heated mold and press cured under moderate pressure until the “cure” or the chemical polymerization reaction reaches the desired degree of completion, either full or partial polymerization. If the material is only partially cured, it is cured sufficiently to retain the form of the friction member, and then the material may then be processed at an elevated temperature, either with or without applied pressure, in a step to further complete the polymerization.

Prior to or in conjunction with the step of forming the friction material, it may be desirable to employ a step of introducing a friction backing having a attachment surface that is adapted and operative to receive pre-polymer friction material mixture. The friction backing is introduced so that the pre-polymer friction material may be formed or polymerized directly onto the attachment surface. This may include the partial or entire covering of the attachment surface. For example, the friction member may encase the friction backing. Alternately, the friction member may cover only a portion friction backing. Prior to introducing the backing member, the method may also include the steps of degreasing and priming the backing member.

Alternately, the friction member may be formed separately and attached to the backing member using an appropriate fastening means, including various adhesives, mechanical fasteners and the like.

### EXAMPLES

Table 1 below provides several exemplary friction materials of the present invention. These examples together with the associated wear data demonstrate the performance improvements described herein, but are merely representative of the friction materials of the invention. The present invention is not restricted to these examples.

Table 1 generally shows nine examples of a friction materials of the invention which includes the requisite combination of flat layered titanate particles and baryte particles in varying amounts together with their associated wear performance as indicated by pad life, both simulated and in actual vehicle tests. The wear performance of these friction materials demonstrate the improvements associated with the invention that are described herein. In these examples, the amounts and constituents comprising the binder, reinforcement fiber and friction modifier were held constant. The relative amounts of the friction modifier constituents were varied to illustrate the improvements associated with both the use of the flat layered titanate particles and the amount of the baryte particles.

The binder was a phenolic resin and was held constant in all of the examples in an amount of 16% by volume of the friction material. The reinforcing fibers were an aramid pulp and were held constant in all of the examples in an amount of 5% by volume of the friction material. The flat layered titanate in the examples consisted of lithium potassium titanate particles in amounts ranging from 5-15% by volume of the friction material. The lithium potassium titanate material used was TERRACESS L made by Otsuka Chemical Co., Ltd. having an average particle size of 15-30 μm. In several of the examples, potassium titanate fibers were used in place of or in combination with the lithium potassium titanate materials. The baryte particles had an average particle size of about 8 μm and a generally spherical shape, and ranged from about 7-25% by volume of the friction material. The overall amount of the friction modifiers in each example was 79% by volume of the friction material. The balance of the friction modifiers in each of the examples was adjusted based on the combined amounts of the potassium lithium titanate and baryte particles to achieve the overall amount of the friction modifier. The balance of the friction modifier constituents included a combination of lubricants, abrasives and fillers. The lubricants ranged from about 8-10% by volume of the friction material, including about 5.6-7% by volume of graphite particles and about 2.4-3% by volume of a blend of various metal sulfides sold by Chemetall GmbH under the tradename CPX72. The abrasives ranged from about 12.1-15% by volume of the friction material, including about 2.4-3.0% by volume of iron oxide particles, about 1.6-2.0% by volume of zircon flour particles and 8.1-10% by volume of zirconia particles. The organic and inorganic fillers ranged from about 25.8-32% by volume of the friction material, including about 3.2-4% by volume of copper fibers, about 0.8-1% by volume of zinc particles, about 7.3-9% by volume of mica particles, about 0.8-1% of rubber particles, about 12.9-16% by volume of friction dust and about 0.8-1% by volume of hydrated lime.

The friction material constituents for each of the examples were mixed to form substantially homogenous mixtures of the constituents. These mixtures were hot pressed to form a friction member 20 in the form of a disc brake friction pad and attached to a suitable pad backing member to form disc brake pads. The brake pads associated with the various examples were inserted into a disc brake assembly and then tested in the laboratory under a variable load profile which has been designed to simulate Los Angeles (LA) city traffic using a dynamometer. This test had previously been correlated to pad wear test results from actual LA city traffic driving tests as are specified by various original equipment vehicle manufacturers The results of these simulations are shown in Table 1, as well as results from several actual LA city traffic tests conducted on several of the examples which generally demonstrate the correlation between the simulated and actual traffic tests. The tests measure the wear of the pads. The tests define the pad life as wear (in miles of travel) to the same amount of overall wear for each of the examples.

TABLE 1

| Constituent | Example 1 | Example 2 | Example 3 | Example 4 | Example 5 | Example 6 | Example 7 | Example 8 | Example 9 |
|---|---|---|---|---|---|---|---|---|---|
| Binder | 16 | 16 | 16 | 16 | 16 | 16 | 16 | 16 | 16 |
| Fibers | 5 | 5 | 5 | 5 | 5 | 5 | 5 | 5 | 5 |
| Friction | 79 | 79 | 79 | 79 | 79 | 79 | 79 | 79 | 79 |
| Modifiers | | | | | | | | | |
| Potassium | 10 | 5 | | | 5 | 8.1 | | | |
| titanate fiber | | | | | | | | | |
| (TXAX-MA) | | | | | | | | | |
| Potassium | | 5 | 10 | 10 | 5 | | 8.1 | 5 | 15 |
| lithium | | | | | | | | | |
| titanate | | | | | | | | | |
| (Terracess L) | | | | | | | | | |
| Abrasive | 15 | 15 | 15 | 15 | 15 | 12.1 | 12.1 | 15 | 15 |
| Lubricants | 10 | 10 | 10 | 11 | 11 | 8 | 8 | 10 | 10 |
| Barytes | 12 | 12 | 12 | 11 | 11 | 25 | 25 | 17 | 7 |
| Other Fillers | 32 | 32 | 32 | 32 | 32 | 25.8 | 25.8 | 32 | 32 |
| Average Pad | 13,164 | 15,900 | 19,350 | 16,100 | 9,850 | 8,700 | 7,300 | 9,900 | 30,850 |
| life (LACT | | | | | | | | | |
| Simulation) | | | | | | | | | |
| (miles) | | | | | | | | | |
| Average Pad | 26,762 | | 47,194 | | | 19,946 | | | |
| Life (LA | | | | | | | | | |
| Vehicle Test) | | | | | | | | | |
| (miles) | | | | | | | | | |

The results from Examples 1-3 and 4-5 demonstrate the wear or pad life improvement associated with the use of the flat layered titanate, in this case potassium lithium titanates, over the use of potassium titanate materials. By replacing fibrous potassium titanate with flat layered titanates, a 47% improvement in pad life was achieved. The results from Examples 1-3 and 4 and 5 demonstrate the wear or pad life improvement associated with the use of the flat layered titanate. Examples 3, 4, 8 and 9 demonstrate the relationship between the amounts of the baryte and the flat layered titanate with regard to the wear life of the pads. As the amount of baryte increases from 7-17% in replacement of the flat layered titanate, there is a corresponding decrease in the pad life. Finally, Examples 6 and 7 demonstrate that the improvement associated with the use of flat layered titanates is completely eliminated, and in fact begins to negatively effect pad life, when the amount of baryte reaches about 25% by volume of the friction material. Controlling the amount of the baryte particles to this level improves the wear resistance of these friction materials over that of friction materials which include flat layered titanate particles and baryte particles above this range. The wear resistance or pad life improvement of friction materials which utilize flat layered titanates decreases with increasing amounts of baryte particles. This data leads to the conclusion that in friction materials that use flat layered titanates, such as potassium lithium titanate, the amount of baryte should be controlled to an amount less than about 25% by volume of the friction material in order to maintain the wear life improvement realized from the use of the flat layered titanate materials.

The foregoing discussion discloses and describes an exemplary embodiment of the present invention. Obviously, many modifications and variations of the present invention are possible in light of the above teachings. It is, therefore, to be understood that within the scope of the appended claims, the invention may be practiced otherwise than as specifically described. One skilled in the art will readily recognize from such discussion, and from the accompanying claims that various changes, modifications and variations can be made therein without departing from the true spirit and fair scope of the invention as defined by the following claims.

What is claimed is:

1. A friction material comprising:
a binder;
a reinforcement fiber; and
a friction modifier comprising flat layered titanate particles and baryte particles, wherein said baryte particles comprise less than about 25% by volume of the friction material.

2. The friction material of claim 1 wherein said flat layered titanate particles comprise alkali metal titanate particles.

3. The friction material of claim 2 wherein said alkali metal titanate particles comprise lithium potassium titanate particles.

4. The friction material of claim 1 wherein said flat layered titanate has the general formula:
AₓM_{y}Ti_{2-y}O₄
wherein A represents an alkaline metal other than lithium; M represents one or more elements selected from the group consisting of lithium, magnesium, zinc, nickel, copper, iron, aluminum, gallium and manganese; x is a number from 0.5-1.0; and y is a number from 0.25-1.0, and flat layered titanic acids represented by general formula (2) as follows:
Hₓ(M′_{y})_{z}Ti_{2-y}O₄.H₂O
wherein M′ represents one or more elements selected from the group consisting of lithium, magnesium, zinc, nickel, copper, iron, aluminum, gallium and manganese; x is a number from 0.5-1.0; y is a number from 0.25-1.0; z is 0 or 1; and n is a number of 0≦n≦2.

5. The friction material as recited in claim 4, wherein A is potassium and M is zinc or magnesium.

6. The friction material as recited in claim 4, wherein M′ is zinc or magnesium.

7. The friction material of claim 1 wherein said flat layered titanate is about 3-25% by volume of the friction material.

8. The friction material of claim 7 wherein said flat layered titanate is about 5-15% by volume of the friction material.

9. The friction material of claim 1 wherein said flat layered titanate has an average particle diameter of approximately 0.1-500 μm.

10. The friction material of claim 9 wherein said flat layered titanate has an average particle diameter of approximately 15-30 μm.

11. The friction material of claim 1 wherein said binder comprises about 8-31% by volume of the friction material.

12. The friction material of claim 1 wherein said reinforcement fibers comprise about 2-13% by volume of the friction material.

13. The friction material of claim 1 wherein said baryte particles comprise less than about 17% by volume of the friction material.

14. A friction material comprising:
a binder;
a reinforcement fiber; and
a friction modifier comprising lithium potassium titanate particles and baryte particles, wherein said baryte particles comprise less than about 25% by volume of the friction material.

15. The friction material of claim 14 wherein said lithium potassium titanate particles comprise about 3-25% by volume of the friction material.

16. The friction material of claim 15 wherein said lithium potassium titanate particles comprise about 5-15% by volume of the friction material.

17. The friction material of claim 14 wherein said lithium potassium titanate particles have an average particle diameter of approximately 0.1-500 μm.

18. The friction material of claim 15 wherein said lithium potassium titanate particles have an average particle diameter of approximately 15-30 μm.

19. The friction material of claim 14 wherein said baryte particles comprise less than about 17% by volume of the friction material.

20. The friction material of claim 14 wherein said friction material comprises a formed friction control member which is attached to a backing member.

21. The friction material of claim 20, wherein said backing member is selected from a group consisting of a disc brake component, a drum brake component and a clutch component.
